(19) United States
(12) Patent Application Publication
(10) Pub. No.: US 2021/0147701 A1
(43) Pub. Date: May 20, 2021

(54) STEALTH WHITE INK, INK SET, AND PRINTING METHOD, AND PRINTING DEVICE

(71) Applicants: Koji KATSURAGI, Kanagawa (JP); Haruki SAITOH, Kanagawa (JP)

(72) Inventors: Koji KATSURAGI, Kanagawa (JP); Haruki SAITOH, Kanagawa (JP)

(21) Appl. No.: 17/086,618

(22) Filed: Nov. 2, 2020

(30) Foreign Application Priority Data
Nov. 18, 2019 (JP) 2019-208132
Sep. 29, 2020 (JP) 2020-163464

(51) Int. Cl. C09D 11/50; C09D 11/322; C09D 11/033; C09D 11/105; G06K 1/12; G06K 7/12; G06K 7/14

(52) U.S. Cl. CPC C09D 11/50; C09D 11/322; C09D 11/033; G06K 7/1434; G06K 1/123; G06K 7/12; C09D 11/105

(57) ABSTRACT

A stealth white ink contains a red coloring material that emits visible light at exposure to ultraviolet radiation, a green coloring material that emits visible light at exposure to ultraviolet radiation, and a blue coloring material that emits visible light at exposure to ultraviolet radiation, wherein a dry film of the stealth white ink has an a* value of from −2.0 to 2.0 and a b* of from −10.0 to 0 at exposure to ultraviolet radiation having a wavelength of 370 nm according to CIE 1976 L*a*b* colorimetric system.

### CROSS-REFERENCE TO RELATED APPLICATIONS

This patent application is based on and claims priority pursuant to 35 U.S.C. § 119 to Japanese Patent Application Nos. 2019-208132 and 2020-163464, filed on Nov. 18, 2019 and Sep. 29, 2020, respectively, in the Japan Patent Office, the entire disclosures of which are hereby incorporated by reference herein.

### BACKGROUND

### Technical Field

The present disclosure relates to a stealth white ink, an ink set containing a stealth white ink and a stealth non-white ink, a printing method, and a printing device,

### Description of the Related Art

Various printed matter, checks, envelopes, and packages are widely marked by bar code for security and verification. Some specific marking methods employ printing with transparent or low coloring ink invisible to human eyes and rendering the ink visible at exposure to specific light such as ultraviolet radiation or infrared radiation. Special ink called stealth ink are used in such methods.

### SUMMARY

According to embodiments of the present disclosure, a stealth white ink is provided which contains a red coloring material that emits visible light at exposure to ultraviolet radiation, a green coloring material that emits visible light at exposure to ultraviolet radiation, and a blue coloring material that emits visible light at exposure to ultraviolet radiation, wherein a dry film of the stealth white ink has an a* value of from −2.0 to 2.0 and a b* value of from −10.0 to 0 at exposure to ultraviolet radiation having a wavelength of 370 nm according to CIE 1976 L*a*b* colorimetric system.

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating a perspective view of an example of a printing device using the ink according to an embodiment of the present disclosure;

FIG. 2 is a diagram illustrating a perspective view of an example of the tank that accommodates the ink according to an embodiment of the present disclosure;

FIG. 3 is a diagram illustrating a perspective view of an example of the head;

FIG. 4 is a block diagram illustrating an example of the system of liquid circulation relating to some embodiments of the present disclosure;

FIG. 5 is a diagram illustrating planar view of an example of a device that discharges ink using a circulation type discharging head; and

FIG. 6 is a diagram illustrating a side view of a part of the device illustrated in FIG. 5.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Moreover, image forming, recording, printing, modeling, etc., in the present disclosure represent the same meaning, unless otherwise specified.

Embodiments of the present invention are described in detail below with reference to accompanying drawing(s). In describing embodiments illustrated in the drawing(s), specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

Embodiments of the present disclosure are described below but are not limiting the present invention. The following is a description for illustration purpose only and the present disclosure is not limited thereto.

Aspects of the present disclosure are, for example, as follows.

(1) A stealth white ink contains a red coloring material that emits visible light at exposure to ultraviolet radiation, a green coloring material that emits visible light at exposure to ultraviolet radiation, and a blue coloring material that emits visible light at exposure to ultraviolet radiation, wherein a dry film of the stealth white ink has an a* value of from −2.0 to 2.0 and a b* value of from −10.0 to 0 at exposure to ultraviolet radiation having a wavelength of 370 nm.
(2) The stealth white ink according to (I) mentioned above, wherein the green coloring material has a least mass ratio of the red coloring material, the green coloring material, and the blue coloring material in the stealth white ink.
(3) The stealth white ink according to (1) mentioned above contains 2.0 to 3.0 parts by mass of the blue coloring material and 2.5 to 3.0 parts by mass of the red coloring material relative to 1.0 part by mass of the green coloring material.
(4) The stealth white ink according to any one of (1) to (3) mentioned above, wherein the stealth white ink demonstrates three fluorescence emission maxima of from 605 to 645 nm, from 505 to 545 nm, and from 445 to 485 nm at exposure to ultraviolet radiation having a wavelength of 365 nm.
(5) The stealth white ink according to any one of (1) to (4) mentioned above further contains an organic solvent having a mixing SP value of 13.0 (cal/cm³)^{0.5} or greater.
(6) The stealth white ink according to any one of (1) to (5) further contains a polyether polyol.
(7) An ink set contains the stealth white ink of any one of (1) to (6) mentioned above and a stealth non-white ink.
(8) A printing method includes applying the stealth white ink of any one of (1) to (6) mentioned above to a substrate and drying the stealth white ink that has been applied to the substrate.
(9) A printing method includes applying the stealth white ink of any one of (1) to (6) mentioned above to a substrate and
applying a stealth non-white ink to the substrate.
(10) The printing method according to (9) mentioned above, wherein, in the applying the stealth white ink, the stealth white ink is applied to the entire surface of the substrate or the region where the stealth non-white ink is applied.
11. A printing device includes a container containing the stealth white ink of any one of (1) to (6) mentioned above or the ink set mentioned in (7); and
a liquid discharging head configured to discharge the stealth white ink and, the liquid discharging head including multiple nozzles, individual liquid chambers communicating with the nozzles, a common supplying liquid chamber configured to supply the stealth white ink to the individual liquid chambers, a circulation path configured to communicate with the individual liquid chambers, a common circulation liquid chamber configured to communicate with the circulation path, and a pressure generator configured to apply a pressure to the stealth white ink in the individual liquid chambers.

Ink

The stealth white ink contains a red coloring material that emits visible light at exposure to ultraviolet radiation, a green coloring material that emits visible light at exposure to ultraviolet radiation, and a blue coloring material that emits visible light at exposure to ultraviolet radiation, wherein a dry film of the stealth white ink has an a* value of from −2.0 to 2.0 and a b* value of from −10.0 to 0 at exposure to ultraviolet radiation having a wavelength of 370 nm. The ideal color tone of white is a*=b*=0. In reality, b* in the tone of the white portions of displays of mobile phones or computers for daily use is shifted to below zero. This is to visually emphasize white by slightly shifting to blue on purpose.

When the a* value is in the range of from −2.0 to 2.0 and the b* value is in the range of from −10.0 to 0, white is visually emphasized. Preferably, the a* value is in the range of from −2.0 to 0 and the b* value is in the range of from −8.5 to −5.0. When the b* value is less than −10.0, white becomes bluish and looks blue rather than white. Conversely, when the b* value surpasses 0, white becomes yellowish and looks yellow rather than white.

Dry film of the stealth white ink looks different depending on the level of luminosity.

It is difficult to visually confirm the difference of output colors or color omission at a luminosity of less than 0.1 mW/cm² of ultraviolet. In contrast, such visual confirmation on the difference of output colors or color omission is easy at a luminosity of not less than 0.1 mW/cm² of ultraviolet. However, at a luminosity of greater than 2.0 mW/cm² of ultraviolet, the image may feel too bright to confirm color omission. Moreover, the image is so bright that the color of the image looks different. In the present disclosure, the luminance of ultraviolet is measured at 370 nm with an ultraviolet illuminometer under a luminance of 2.0 mW/cm².

A print sample is prepared by printing at a printing resolution of 600×600 dpi with an amount attached at 0.8 mg/cm² followed by drying at room temperature for one day and one night. The a* value and b* value of this print sample are measured.

The stealth white ink of the present disclosure contains coloring materials of red, green, and blue. The mixing ratio of these coloring materials should be arranged to demonstrate the color of the a* value and b* value mentioned above. It is preferable that the mass ratio of the green coloring material be the least of the three coloring materials. It is more preferable that the stealth white ink contain 2.0 to 3.0 parts by mass of the blue coloring material and 2.5 to 3.0 parts by mass of the red coloring material relative to 1.0 part by mass of the green coloring material.

When the stealth white ink is exposed to 365 nm ultraviolet radiation, it is preferable that the red coloring material, the green coloring material, and the blue coloring material respectively have an emission maximum in a range of from 605 to 645 nm, from 505 to 545 nm, and from 445 to 485 nm.

When the coloring materials are mixed at the mass ratio mentioned above to prepare white ink, it is preferable that the hue angle of a dry film of liquid dispersion of each color as base at 370 nm ultraviolet be preferably as follows:

Red liquid dispersion: hue angle=15 to 35 degrees;
Green liquid dispersion: hue angle=120 to 140 degrees; and
Blue liquid dispersion: hue angle=290 to 310 degrees.

The dry film of liquid dispersion of each color as the base is obtained by applying each liquid dispersion at 5 ml onto a glass substrate with an amount of 0.8 mg/cm² by a bar coater followed by drying at 80 degrees C. for three hours.

The organic solvents, water, coloring materials, resins, and additives for use in the stealth white ink (hereinafter also referred to as ink) are described below.

Organic Solvent

There is no specific limitation to the organic solvent for use in the present disclosure. For example, a water-soluble organic solvent can be used. Examples include, but are not limited to, polyhydric alcohols, ethers such as polyhydric alcohol alkylethers and polyhydric alcohol arylethers, nitrogen-containing heterocyclic compounds, amides, amines, and sulfur-containing compounds.

Specific examples of the water-soluble organic solvent include, but are not limited to: polyhydric alcohols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane trial, 1,2,3-butanetriol, 2,2,4-trimethyl-1,3-pentanediol, and petriol; polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyol aryl ethers such as ethylene glycol monophenyl ether and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propioneamide, and 3-buthoxy-N,N-dimethyl propioneamide; amines such as monoethanolamine, diethanolamine, and triethylamine; sulfur-containing compounds such as dimethyl sulfoxide, sulfolane, and thiodiethanol; propylene carbonate, and ethylene carbonate.

It is preferable to use an organic solvent having a boiling point of 250 or lower degrees C., which serves as a humectant and imparts a good drying at the same time.

The organic solvent in the ink preferably has a mixing SP value of 13.0 (cal/cm³)^{0.5} or greater to enhance the storage stability of the ink.

In the present disclosure, the mixing SP value of the organic solvent is calculated according to the following relationship only for the organic solvents having a proportion of 3.0 percent by mass or greater in the ink.

Mixing SP value (cal/cm³)^{0.5} of organic solvents in ink=[SP value of organic solvent S₁×volume fraction of organic solvent S₁]+ . . . +[SP value of organic solvent Sₙ×volume fraction of organic solvent Sₙ]

Polyol compounds having eight or more carbon atoms and glycol ether compounds are also suitable. Specific examples of the polyol compounds having eight or more carbon atoms include, but are not limited to, 2-ethyl-1,3-hexanediol and 2,2,4-trimethyl-1,3-pentanediol. Specific examples of the glycolether compounds include, but are not limited to, polyhydric alcohol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether and polyhydric alcohol arylethers such as ethylene glycol monophenylether and ethylene glycol monobenzylether.

The polyhydric alcohol or polyol compounds having eight or more carbon atoms and glycolether compounds enhance permeability of ink for paper used as a recording medium.

The proportion of the organic solvent in the ink has no particular limit and can be suitably selected to suit to a particular application.

In terms of drying and discharging reliability of the ink, the proportion is preferably from 10 to 60 percent by mass and more preferably from 20 to 60 percent by mass.

Water The proportion of water in the ink is not particularly limited and can be suitably selected to suit to a particular application. In terms of drying and discharging reliability of the ink, the proportion is preferably from 10 to 90 percent by mass and more preferably from 20 to 70 percent by mass.

Coloring Material

As the coloring material for use in the present disclosure that emits visible light at ultraviolet radiation, specific examples of the red coloring material include, but are not limited to, complexes coordinated with one or two ligands such as 4,4,4-trifluoro-1-(2-thienyl)-1,3-butanedione, 4,4,4-trifluoro-1-phenyl-1,3-butanedione, and tri-n-octyl phosphine oxide.

Specific examples of the green coloring material include, but are not limited to, 3-(2-quinolylmethylene)isoindrine-3-on, 2-[2-oxo-7(dimethylamino)-2H-1-benzopylan-3yl]-1,3-dimethyl-1H-benzoimidazole-3-ium-methylsulfate, and 3-(5-chloro-2-benzooxazoyl)-7-(dimethylamino)-2H-1-benzopylan-2-on.

Specific examples of the blue coloring material include, but are not limited to, benzooxazole fluorescent brighteners such as 1,2-bis(5-methylbenzooxazole-2-yl)ethene, 2,2′-(1,2-ethendiyl)bis(4,1-phenylene)bisbenzooxazole, and 2,2′-(2,5-thiophendiyl)bis(5-tert-butyl benzooxazole), stilben fluorescent brighteners, and qumarin fluorescent brighteners.

It is also possible to manufacture ink by mixing materials such as water and an organic solvent with a liquid dispersion which is prepared by mixing a coloring material that emits visible light at ultraviolet radiation with other materials such as water and a dispersing agent.

The proportion of the coloring material that emits visible light at ultraviolet radiation in the ink is preferably from 0.005 to 10.0 percent by mass and more preferably from 0.025 to 5.0 percent by mass to enhance intensity of emission, fixability, and discharging stability.

When the ink contains resin particles dyed with the coloring material that emits visible light at ultraviolet radiation, the proportion of the resin particles dyed with the coloring material that emits visible light at ultraviolet radiation is from 0.1 to 20 percent by mass and more preferably from 5 to 20 percent by mass of the ink.

The stealth white ink of the present disclosure preferably contains resin particles to be dyed with the coloring material. Such resin particles are obtained by aqueous emulsion polymerization, preferably composed of copolymers contained in the aqueous liquid dispersion, and more preferably have a volume average particle diameter of 200 nm or less. Discharging stability is maintained without degradation and storage stability is kept excellent without precipitation of resin particles in aqueous ink when the resin particles have a volume average particle diameter of 200 nm or less.

The volume average particle diameter can be measured by using, for example, a particle size analyzer (Nanotrac Wave-UT151, manufactured by MicrotracBEL Corp.).

Emulsion polymerization is suitably selected according to the type and the amount of surfactants. The polymerization temperature is preferably from 50 to 90 degrees C.

Specific examples of the polymerization initiator includes, but are not limited to, ammonium persulfate, potassium persulfate, and hydrogen peroxide, which can be optionally used in combination with a reducing agents.

The copolymers for use in the stealth white ink of the present disclosure are synthesized by emulsion polymerization preferably using methacrylates such as vinyl acetate, styrene, methyl methacrylate, ethyl methacrylate, and butyl methacrylate, acrylates such as methyl acrylate, ethyl acrylate, and butyl acrylate, polymeric monomers such as acrylic nitrile and methacrylonitrile, polymeric surfactants, ammonium persulfate, potassium persulfate, and hydrogen peroxide as a polymerization initiator optionally with a reducing agent in combination.

It is preferable to use the coloring material that emits visible light at exposure to ultraviolet radiation as a liquid dispersion which is prepared by dyeing resin particles with the coloring material by emulsion polymerization followed by mixing with water. The resin particles can be dyed during or after emulsion polymerization. It is preferable to stir the materials under atmospheric pressure or under an increased pressure at 40 to 110 degrees C. for one to five hours. The proportion of the coloring material to resin particles (solid portion of emulsion polymerization) is preferably from 0.01 to 15.0 percent by mass and more preferably from 0.05 to 8.0 percent by mass.

The stealth white ink may contain the following resins, although the coloring material that emits visible light at exposure to ultraviolet radiation is preferably used as a liquid dispersion prepared by dyeing resin particles by emulsion polymerization followed by mixing with water.

Resin

The type of the resin contained in the ink has no particular limit and can be suitably selected to suit to a particular application. Examples include, but are not limited to, urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins.

It is possible to use resin particles made of these resins and possible to prepare ink by mixing a resin emulsion containing resin particles which are dispersed in water as a dispersion medium with materials such as a liquid dispersion containing a coloring material and an organic solvent. It is possible to use suitably-synthesized resin particles as the resin particle. Alternatively, the resin particle are procurable. The resin particle can be used alone or in combination.

The mean volume diameter (i.e., volume average particle diameter) of the resin particle is not particularly limited and can be suitably selected to suit to a particular application. The mean volume diameter is preferably from 10 to 1,000 nm, more preferably from 10 to 200 nm, and particularly preferably from 10 to 100 nm to achieve good fixability and image robustness.

The volume average particle diameter can be measured by using a device such as a particle size analyzer (Nanotrac Wave-UT151, manufactured by MicrotracBEL Corp.).

The proportion of the resin in the ink is not particularly limited, can be suitably selected to suit to a particular application, and is preferably from 1 to 30 percent by mass and more preferably from 5 to 20 percent by mass of the total amount of the ink to enhance fixability and storage stability of the ink.

The particle diameter of the solid portion in the ink has no particular limit and can be suitably selected to suit to a particular application. For example, the maximum frequency in the maximum number conversion is preferably from 20 to 1,000 nm and more preferably from 20 to 150 nm to ameliorate the discharging stability and image quality such as image density. The solid portion includes particles such as resin particles and pigment particles. The particle diameter can be measured by using a particle size analyzer (Nanotrac Wave-UT151, manufactured by MicrotracBEL Corp).

Additive

The ink may further optionally include additives such as a surfactant, a defoaming agent, a preservative and fungicide, a corrosion inhibitor, and a pH regulator.

Surfactant Examples of the surfactant include, but are not limited to, silicone-based surfactants, fluorochemical surfactants, amphoteric surfactants, nonionic surfactants, and anionic surfactants.

The silicone-based surfactant has no specific limit and can be suitably selected to suit to a particular application.

Of these, surfactants not decomposable in a high pH environment are preferable. Examples of the silicone-based surfactants include, but are not limited to, side chain modified polydimethyl siloxane, both terminal-modified polydimethyl siloxane, one-terminal-modified polydimethyl siloxane, and side-chain-both-terminal-modified polydimethyl siloxane. In particular, silicone-based surfactants having a polyoxyethylene group or a polyoxyethylene polyoxypropylene group as a modification group are particularly preferable because such an aqueous surfactant demonstrates good properties. It is possible to use a polyether-modified silicone-based surfactant as the silicone-based surfactant. A specific example is a compound in which a polyalkylene oxide structure is introduced into the side chain of the Si site of dimethyl silooxane.

Specific examples of the fluorochemical surfactant include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because the fluorochemical surfactant does not readily produce foams.

Specific examples of the perfluoroalkyl sulfonic acid compounds include, but are not limited to, perfluoroalkyl sulfonic acid and salts of perfluoroalkyl sulfonic acid.

Specific examples of the perfluoroalkyl carbonic acid compounds include, but are not limited to, perfluoroalkyl carbonic acid and salts of perfluoroalkyl carbonic acid.

Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain.

Specific examples of the counter ion of the salt of these fluorochemical surfactants include, but are not limited to, Li, Na, K, NH₄, NH₃CH₂CH₂OH, NH₂(CH₂CH₂OH)₂, and NH(CH₂CH₂OH)₃.

Specific examples of the ampholytic surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The silicone-based surfactant has no particular limit and can be suitably selected to suit to a particular application. Specific examples include, but are not limited to, side-chain-modified polydimethyl siloxane, both distal-end-modified polydimethyl siloxane, one-distal-end-modified polydimethyl siloxane, and side-chain-both-distal-end-modified polydimethyl siloxane. In particular, a polyether-modified silicone-based surfactant having a polyoxyethylene group or a polyoxyethylene polyoxypropylene group is particularly preferable because such a surfactant demonstrates good property as an aqueous surfactant.

Any suitable synthetic surfactant and any product available on the market is suitable. Products are available from BYK-Chemie GmbH, Shin-Etsu Silicone Co., Ltd., Dow Corning Toray Co., Ltd., NIHON EMULSION Co., Ltd., Kyoeisha Chemical Co., Ltd., and others.

The polyether-modified silicon-based surfactant has no particular limit and can be suitably selected to suit to a particular application. For example, a compound is usable in which the polyalkylene oxide structure represented by the following Chemical Formula S-1 is introduced into the side chain of the Si site of dimethyl polysiloxane.

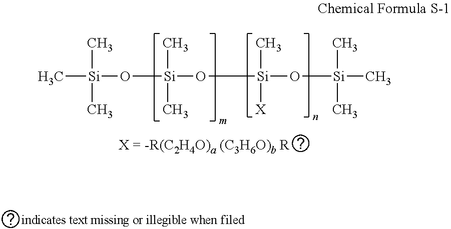

In Chemical Formula S-1, “m”, “n”, “a”, and “b” each, respectively independently represent integers, R represents an alkylene group, and R′ represents an alkyl group.

Specific examples of the polyether-modified silicone-based surfactant include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Co., Ltd.), BYK-33 and BYK-387 (both manufactured by BYK Chemie GmbH), and TSF4440, TSF4452, and TSF4453 (all manufactured by Momentive Performance Materials Inc.).

A fluorochemical surfactant in which the number of carbon atoms replaced with fluorine atoms is 2 to 16 is preferable and, 4 to 16, more preferable.

Specific examples of the fluorochemical surfactant include, but are not limited to, perfluoroalkyl phosphoric acid ester compounds, adducts of perfluoroalkyl with ethylene oxide, and polyoxyalkylene ether polymer compounds having a perfluoroalkyl ether group in its side chain. Of these, polyoxyalkylene ether polymer compounds having a perfluoroalkyl ether group in its side chain are preferable because these do not easily foam and the fluorochemical surfactant represented by the following Chemical Formula F-1 or Chemical Formula F-2 is preferable.

CF₃CF₂(CF₂CF₂)ₘ—CH₂CH₂O(CH₂CH₂O)ₙH Chemical Formula 2

In the Chemical Formula F-1, “m” is preferably 0 or an integer of from 1 to 10 and “n” is preferably 0 or an integer of from 1 to 40.

CₙF₂ₙ₊₁—CH₂CH(OH)CH₂—O—(CH₂CH₂O)ₙ—Y Chemical Formula F-2

In the compound represented by the Chemical Formula F-2, Y represents H or CₘF₂ₘ₊₁, where m represents an integer of from 1 to 6, or CH₂CH(OH)CH₂—CₘF₂ₘ₊₁, where m represents an integer of from 4 to 6, or CₚH₂ₚ₊₁, where p is an integer of from 1 to 19, n represents an integer of from 1 to 6. a represents an integer of from 4 to 14.

The fluorochemical surfactant is commercially available.

Specific examples include, but are not limited to, SURFLON S-111, S-112, S-113, S-121, S-131, S-132, S-141, and S-145 (all manufactured by ASAHI GLASS CO., LTD.); FLUORAD FC-93, FC-95, FC-98, FC-129, FC-135, FC-170C, FC-430, and FC-431 (all manufactured by SUMITOMO 3M); MEGAFACE F-470, F-1405, and F-474 (all manufactured by DIC CORPORATION); ZONYL TBS, FSP, FSA, FSN-100, FSN, FSO-100, FSO, FS-300, UR, and Capstone™ FS-30, FS-31, FS-3100, FS-34, and FS-35 (all manufactured by The Chemours Company); FT-110, FT-250, FT-251, FT-400S, FT-150, and FT-400SW (all manufactured by NEOS COMPANY LIMITED); POLYFOX PF-136A, PF-156A, PF-151N, PF-154, and PF-159 (manufactured by OMNOVA SOLUTIONS INC.); and UNIDYNE™ DSN-403N (manufactured by DAIKIN INDUSTRIES, Ltd.). Of these, in terms of improvement on print quality, in particular coloring property and permeability, wettability, and uniform dying property on paper, FS-3100, FS-34, and FS-300 of The Chemours Company, FT-110, FT-250, FT-251, FT-400S, FT-150, and FT-400SW of NEOS COMPANY LIMITED, POLYFOX PF-151N of OMNOVA SOLUTIONS INC., and UNIDYNE™, DSN-403N (manufactured by DAIKIN INDUSTRIES, Ltd.) are particularly preferable.

The proportion of the surfactant in the ink is not particularly limited and can be suitably selected to suit to a particular application. For example, the proportion is preferably from 0.001 to 5 percent by mass and more preferably from 0.05 to 5 percent by mass to achieve excellent wettability and discharging stability and improve image quality.

Defoaming Agent

The defoaming agent has no particular limit and examples include, but are not limited to, acetylene glycol based defoaming agents, silicon-based defoaming agents, polyether-based defoaming agents, and aliphatic acid ester-based defoaming agents. These can be used alone or in combination. Of these, silicone-based defoaming agents are preferable to achieve the effect of foam breaking.

Preservatives and Fungicides

The preservatives and fungicides are not particularly limited. A specific example is 1,2-benzisothiazoline-3-one.

Corrosion Inhibitor

The corrosion inhibitor has no particular limitation. Examples are acid sulfites and sodium thiosulfates.

pH Regulator

The pH regulator has no particular limit as long as it can control pH to be not lower than 7. Specific examples include, but are not limited to, amines such as diethanol amine and triethanol amine.

Fluorescent Brightener

In the present disclosure, a fluorescent brightener can be used to improve the effect of the fluorescence of the coloring material. Fluorescent brighteners improve dispersibility of coloring material and enhance the effect of the coloring material by surface migration. A specific example is polyether polyol.

The proportion of the fluorescent brightener in the ink is preferably from 0.2 to 2 percent by mass and more preferably from 0.5 to 2 percent by mass to the content of the coloring material. The target brightness can demonstrate at a proportion of a fluorescent brightener of 0.2 percent by mass or greater to the content of the coloring material. Conversely, when the proportion is 2 percent by mass or less, discharging stability can be enhanced.

A specific example of the procurable fluorescent brightener is Optiact 1-10 (manufactured by San Nopco Ltd.).

Properties of the ink are not particularly limited and can be suitably selected to suit to a particular application. For example, viscosity, surface tension, and pH are preferable in the following ranges.

Viscosity of the ink at 25 degrees C. is preferably from 5 to 30 mPa·s and more preferably from 5 to 25 mPa·s because print density and text quality improve and good dischargeability is demonstrated. Viscosity can be measured by, for example, a rotatory viscometer (RE-80L, manufactured by TOKI SANGYO CO., LTD.). The measuring conditions are as follows:
Standard cone rotor (1°34′×R24)
Sample liquid amount: 1.2 mL
Rotational frequency: 50 rotations per minute (rpm)
25 degrees C.
Measuring time: three minutes.

The surface tension of the ink is preferably 35 mN/m or less and more preferably 32 mN/m or less at 25 degrees C. because the ink suitably levels on a recording medium and the ink is dried in a shorter time.

pH of the ink is preferably from 7 to 12 and more preferably from 8 to 11 to prevent corrosion of metal material in contact with liquid.

In the present disclosure, zeta potential can be used as an index for dispersion stability of the stealth white ink.

Zeta potential is known as an index for dispersion stability of a particle and defined as the potential at the slipped surface to the zero potential at an electrically neutral region sufficiently distant from the particle. Fine particles are more stabilized as the absolute value of the zeta potential increases because repulsion between the fine particles increases. To the contrary, particles readily agglomerate as the zeta potential approaches zero.

It is preferable in the present disclosure that zeta potential at a pH of 9 of liquid diluted with deionized water to achieve a total concentration of each of the coloring materials in the stealth white ink of 0.01 percent by mass be −20 mV or lower. This zeta potential increases repulsion between particles and stabilizes the particles so that ink having excellent storage stability can be obtained.

It is preferable that zeta potential at a pH of 9 of liquid diluted with deionized water to achieve a total concentration of each of the resin particles dyed with the coloring materials that emit light at ultraviolet radiation of 0.01 percent by mass be −20 mV or lower to contain resin particles with the coloring material in the ink. This zeta potential increases repulsion between particles and stabilizes the particles so that ink having excellent storage stability can be obtained.

The total concentration of each coloring material or resin particles dyed with the coloring material in ink can be obtained by preliminarily isolating the coloring material or the resin particles dyed with the coloring material by subjecting ink to centrifugal. Based on the obtained concentration, the ink is diluted with deionized water to adjust the total concentration of each coloring material or resin particles dyed with the coloring material to be 0.01 percent by mass.

It is possible to add acid or alkaline aqueous solution such as hydrochloric acid water and an aqueous solution of sodium hydroxide to adjust the pH of the ink.

Pre-Processing Fluid

It is possible to use a pre-processing fluid containing an ultraviolet absorbent to eliminate the impact of the fluorescent brightener which is preliminarily contained in a substrate.

The pre-processing fluid may include an ultraviolet absorbent, an organic solvent, water, and optional materials such as a surfactant, a defoaming agent, a pH regulator, a preservatives and fungicides, and a corrosion inhibitor.

The organic solvent, the surfactant, the defoaming agent, the pH regulator, the preservatives and fungicides, and the corrosion inhibitor can be the same material as those for use in the ink. Also, other material for use in known processing fluid can be used.

Specific examples of the ultraviolet absorbents include, but are not limited to, octyl methoxy cinnamate, dimethoxy bendiridene dioxoimidazolidine octyl propionate, diethyl aminohydroxy benzoyl hexyl benzoate, tert-butyl methoxy dibenzoyl methane, octyl triazone, and paramethoxy 2-ethylhexyl cinnamate.

Print Medium

The print medium (hereinafter also referred to as recording medium) is not particularly limited and includes plain paper, gloss paper, special paper, cloth, film, transparency, and print paper for general purpose. It is preferable to select print media free of fluorescent brightener because such a fluorescent brightener may damage the color tone of the stealth ink.

The recording media are not limited to typical recording media and suitably include building materials such as wall paper, floor material, and tiles, cloth for apparel such as T-shirts, textile, and leather. The configuration of the paths through which the recording medium is conveyed can be changed to use materials such as ceramics, glass, and metal.

Printed Matter

The ink printed matter in the present disclosure includes a print medium and an image formed on the print medium with the ink of the present disclosure.

The printed product can be obtained by creating images by the inkjet printing device executing the inkjet printing method.

The stealth white ink of the present disclosure can be used in combination with stealth non-white ink as an ink set.

The first stealth ink for use in the present disclosure is a white ink containing all of a red coloring material, green coloring material, and blue coloring material that emit visible light at ultraviolet radiation and the second stealth ink is a non-white ink containing one of a red coloring material, green coloring material, and blue coloring material that emit visible light at ultraviolet radiation.

The first stealth ink is applied before the second stealth ink is applied in the present disclosure. The first stealth ink is applied to the entire surface of a substrate or the same region of a substrate as the second stealth ink is applied.

It is preferable to apply and dry the stealth white ink and thereafter apply the stealth non-white ink. It is preferable to dry the stealth white ink at 90 degrees C. for one minute.

Printing Device and Printing Method

The ink of the present disclosure can be suitably applied by various inkjet printing devices such as printers, facsimile machines, photocopiers, multifunction peripherals (serving as a printer, facsimile machine, and photocopier), and solid freeform fabrication devices such as 3D printers and additive manufacturing devices.

In the present disclosure, the printing device and the print method respectively represent a device capable of discharging ink and various processing fluids to a print medium and a method of printing utilizing the device. The print medium means an item to which ink or various processing fluids can be temporarily or permanently attached.

The printing device may further optionally include a device relating to feeding, conveying, and ejecting a print medium and other devices referred to as a pre-processing device, a post-processing device in addition to the head portion to discharge the ink.

The printing device and the printing method may further optionally include a heating device (heater) for use in the heating process and a drying device (drier) for use in the drying process. For example, the heating device and the drying device heat and dry the print surface and the opposite surface of a print medium. The heating device and the drying device are not particularly limited. For example, a fan heater and an infra-red heater can be used. It is possible to heat and dry a print medium before, during, and after printing.

In addition, the printing device and the print method are not limited to those producing meaningful visible images such as texts and figures with the ink. For example, the print method and the printing device capable of producing patterns like geometric design and 3D images are included.

In addition, the printing device includes both a serial type device in which the liquid discharging head moves and a line type device in which the liquid discharging head is not moved, unless otherwise specified.

Furthermore, in addition to the desktop type, this printing device includes a device capable of printing images on a wide print medium having, for example, AO size and a continuous printer capable of using continuous paper rolled in a roll-like form as a print medium.

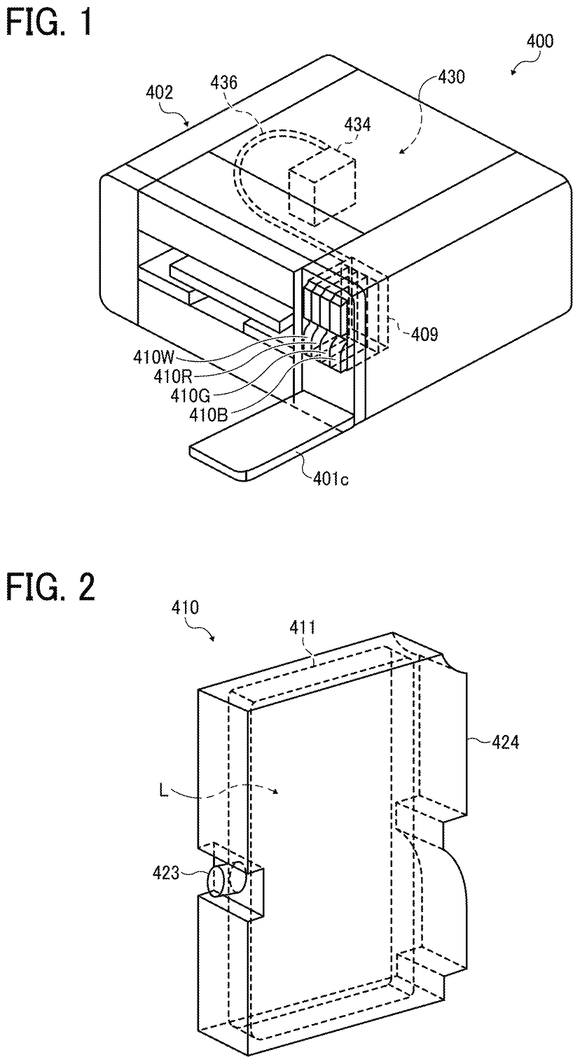

The printing device is described using an example with reference to FIG. 1 and FIG. 2. FIG. 1 is a diagram illustrating a perspective view of the printing device. FIG. 2 is a diagram illustrating a perspective view of a (main) tank. An image forming device 400, which is an embodiment of the printing device, is a serial type image forming device. A mechanical assembly 430 is disposed in an exterior 402 of the image forming device 400. Each ink accommodating unit (ink container) 411 of each tank 410 (410W, 410R, 410G, and 410B) for each color of white (W), red (R), green (G), and blue (B) is made of a packaging member such as aluminum laminate film. The ink accommodating unit 411 is housed in, for example, a plastic container housing unit 424 and L represents liquid contained in the ink accommodating unit 411. As a result, the tank 410 is used as an ink cartridge of each color.

A cartridge holder 409 is disposed on the rear side of the opening formed when a cover 401c is opened. The cartridge holder 409 is detachably attached to the tank 410. In this configuration, each ink discharging outlet 423 of the tank 410 communicates with a discharging head 434 for each color via a supplying tube 436 for each color and the ink can be discharged from the discharging head 434 to a print medium.

The printing device includes a container containing the stealth white ink and a liquid discharging head (circulation type discharging head) that discharges the stealth white ink, wherein the liquid discharging head includes multiple nozzles, individual liquid chambers, a common supplying liquid chamber that supplies the stealth white ink to the individual liquid chambers, a circulation path that communicates with the individual liquid chambers, a common circulation liquid chamber that communicates with the circulation path, and a pressure generator that applies a pressure to the stealth white ink in the individual liquid chambers.

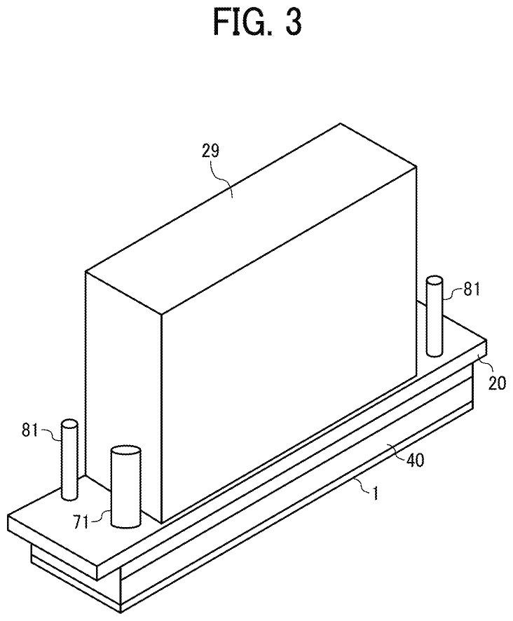

An embodiment of the liquid discharging head is described with reference to the drawings. FIG. 3 is a diagram illustrating a perspective view of an example of the head.

The head illustrated in FIG. 3 includes a common liquid chamber member 20, a supply port 71 as an influx path to flow the ink into the common liquid chamber member 20, an efflux path member 40 to flow the ink out from the common liquid chamber member 20, a nozzle plate 1 communicating with the efflux path member 40 and having a nozzle for discharging the ink, and two circulation ports 81 as a circulating device to circulate the ink in the common liquid chamber member 20.

The head may include a head cover 29.

The circulation ports 81 as the circulating device can circulate the ink in either direction.

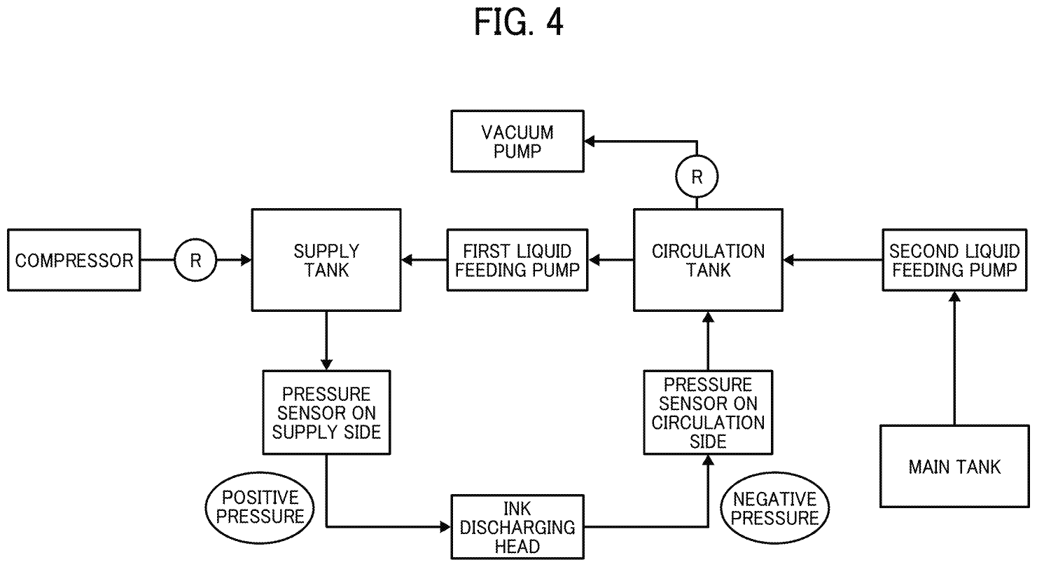

Next, an example of the liquid circulation system using the head relating to the present embodiment is described with reference to FIG. 4.

FIG. 4 is a block diagram illustrating the liquid circulation system relating to the present embodiment of the present disclosure.

As illustrated in FIG. 4, the liquid circulation system includes devices such as a main tank, a liquid discharging head, a supply tank, a circulation tank, a pressure generating device (compressor), a vacuum pump, a liquid feeding pump, a regulator (R), a pressure sensor on the supply side, and a pressure sensor on the circulation side. The pressure sensor on the supply side is disposed between the supply tank and the liquid discharging head and connected on the supply flow channel side connected with the supply port 71 (FIG. 3) of the liquid discharging head. The pressure sensor on the circulation side is disposed between the liquid discharging head and the circulation tank and connected on the circulation flow channel side connected to the circulation port 81 of the liquid discharging head.

One end of the circulation tank is connected to the supply tank via the first liquid feeding pump and, the other end, with the main tank via the second liquid feeding pump. Due to this configuration, the liquid flows from the supply tank into the liquid discharging head through the supply port 71 and ejected to the circulation tank through the circulation port. Furthermore, the liquid is sent from the circulation tank to the supply tank by the first liquid feeding pump to circulate the liquid.

In addition, a compressor is connected to the supply tank, which is controlled in order that the pressure sensor on the supply side can detect a predetermined positive pressure. In addition, a vacuum pump is connected to the circulation tank, which is controlled in order that the pressure sensor on the circulation side can detect a predetermined negative pressure. Therefore, the negative pressure of the meniscus can be maintained constant while circulating the liquid through the liquid discharging head.

In addition, as a liquid droplet is discharged from the nozzle of the liquid discharging head, the amount of the liquid in the supply tank and the circulation tank decreases. Therefore, it is desirable to replenish the liquid from the main tank to the circulation tank using the second liquid feeding pump on suitable occasions. When to replenish the liquid from the main tank to the circulation tank can be controlled based on the detection result of, for example, a liquid surface sensor disposed in the circulation tank to replenish the liquid when the liquid surface height of the liquid in the circulation tank becomes lower than a predetermined height.

Next, the circulation of the liquid in the head is described. As illustrated in FIG. 3, the supply port 71 communicating with the common liquid chamber 20 and the circulation ports 81 communicating with the circulation common liquid chamber are formed at ends of the common liquid chamber 20. The supply port 71 and the circulation ports 81 are respectively connected with the supply tank and the circulation tank to store the liquid via respective tubes. The liquid stored in the supply tank is supplied to the individual liquid chambers via the supply port 71 and others.

Moreover, while the liquid in the individual liquid chambers is discharged from nozzles, all or part of the liquid not discharged but remaining in the individual liquid chambers circulates to the circulation tank via the circulation ports 81.

The liquid can be circulated during both operation and downtime of the head. Circulation of the liquid during downtime is preferable because the liquid in the individual liquid chamber 6 is always refreshed and the components contained in the liquid is prevented from agglomerating or settling out.

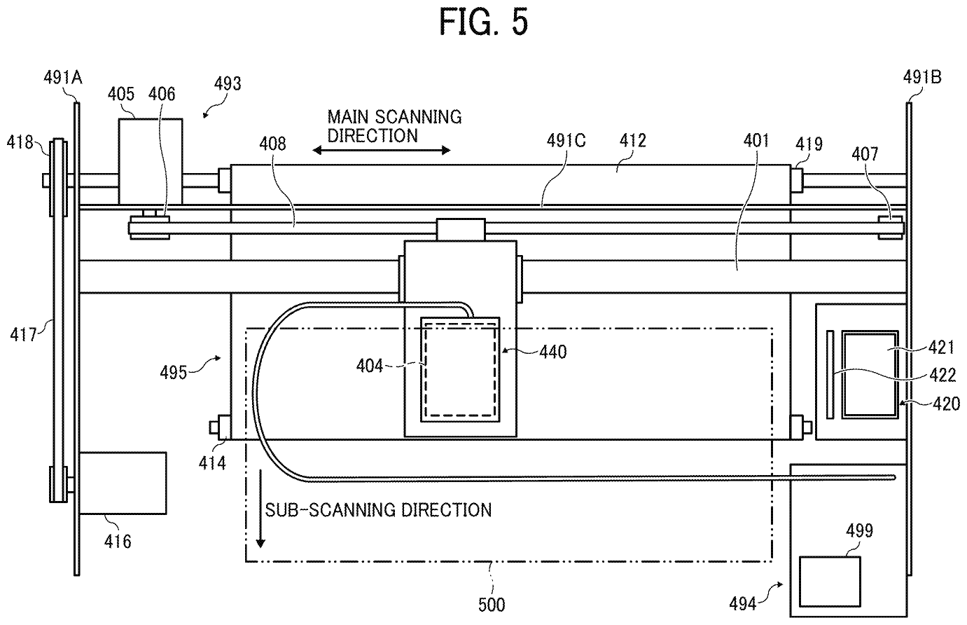

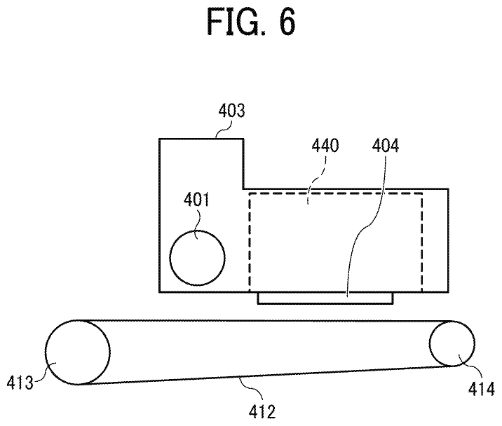

Next, an example of a device that discharges ink using a circulation discharging head is described with reference to FIGS. 5 and 6. FIG. 5 is a diagram illustrating a plane view illustrating an example of the substantial part of the device and FIG. 6 is a diagram illustrating a side view of the substantial part of the device.

This device is a serial type, and a main scanning moving assembly 493 reciprocates the carriage 403 in the main scanning direction. The main scanning moving assembly 493 includes a guiding member 401, a main scanning motor 405, and a timing belt 408. The guiding member 401 is bridged between a side plate 491A and a side plate 491B disposed on the right and left sides, respectively and holds the carriage 403 movable. The main scanning motor 405 reciprocates the carriage 403 in the main scanning direction via the timing belt 408 stretched between a drive pully 406 and a driven pully 407.

The carriage 403 carries an ink discharging unit 440 on which an ink discharging head 404 is mounted. The ink discharging head 404 of the ink discharging unit 440 discharges color inks such as white (W), red (R), green (G), and blue (B). The ink discharging head 404 carries a nozzle line having multiple nozzles along the sub-scanning direction vertical to the main scanning direction with the ink discharging surface downward.

The circulation assembly 494 including a pressure generating device (compressor) 499 supplies and circulates ink in the ink discharging head 404 to supply the ink stored outside the ink discharging head 404 to the ink discharging head 404. In this embodiment, the circulation assembly 494 includes a supply tank, a circulation tank, a compressor, a vacuum pump, a liquid feeding pump, a regulator (R), etc. The pressure sensor on the supply side is disposed between the supply tank and the ink discharging head 404 and connected on the supply flow channel side connected to the supply port 71 of the ink discharging head 404. The pressure sensor on the circulation side is disposed between the ink discharging head 404 and the circulation tank and connected to the circulation flow channel side connected to the circulation port 81 of the ink discharging head 404.

This device includes a conveyance assembly 495 to convey a recording medium 500. The conveyance assembly 495 includes a conveyor belt 412 as a conveying device and a sub-scanning motor 416 to drive the conveyor belt 412.

The conveyor belt 412 adsorbs the recording medium 500 and conveys it to the position facing the ink discharging head 404. The conveyor belt 412 has an endless form, stretched between a conveyor roller 413 and a tension roller 414. The conveyor belt 412 electrostatically adsorbs or aspirates the recording medium 500.

The conveyor belt 412 is moved around in the sub-scanning direction by the conveyor roller 413 rotationally driven by the sub-scanning motor 416 via a timing belt 417 and a timing pully 418.

Furthermore, on one side of the carriage 403 in the main scanning direction, a maintenance and recovery assembly 420 to maintain and recover the ink discharging head 404 is disposed on the side of the conveyor belt 412.

The maintenance and recovery assembly 420 includes a capping member 421 to cap a nozzle surface (surface on which the nozzle is formed) of the ink discharging head 404, a wiping member 422 (wiper) to wipe off the nozzle surface, etc.

The main scanning moving assembly 493, the circulation assembly 494, the maintenance and recovery assembly 420, and the conveyance assembly 495 are mounted onto a housing including the side plates 491A and 491B and a back plate 491C.

In the image forming device having such a configuration, the recording medium 500 is fed and adsorbed onto the conveyor belt 412 and conveyed along the sub-scanning direction by the rotational movement of the conveyor belt 412.

Thereafter, the ink discharging head 404 is driven in response to an image signal while moving the carriage 403 in the main-scanning direction so that the ink is discharged onto the recording medium 500 standing still to record an image.

Since this device includes a circulation discharging head, quality images can be stably formed.

This printing device may include not only a portion to discharge ink but also a device referred to as a pre-processing device and a post-processing device.

As an example of the pre-processing device and the post-processing device, the pre-processing device and the post-processing device may further include a liquid accommodating unit including a pre-processing liquid or a post-processing liquid like the ink of white (W), red (R), green (G), and blue (B) and a liquid discharging head to discharge the pre-processing liquid or the post-processing liquid by inkjet printing.

It is possible to dispose a pre-processing device and a post-processing device in one embodiment which do not employ the inkjet printing method but a blade coating method, a roll coating method, or a spray coating method.

Notably, the ink is applicable not only to the inkjet recording but can be widely applied in other methods.

Specific examples of such methods other than the inkjet recording include, but are not limited to, blade coating methods, gravure coating methods, bar coating methods, roll coating methods, dip coating methods, curtain coating methods, slide coating methods, die coating methods, and spray coating methods.

The usage of the ink of the present disclosure is not particularly limited and can be suitably selected to suit to a particular application. For example, the ink can be used for printed matter, a paint, a coating material, and foundation. The ink can be used to produce two-dimensional text and images and furthermore used as a material for solid fabrication for manufacturing a solid fabrication object (or solid freeform fabrication object).

The solid fabrication apparatus to fabricate a solid fabrication object can be any known device with no particular limit. For example, the apparatus includes a container, supplying device, discharging device, drier of ink, and others.

The solid fabrication object includes an object manufactured by repetitively coating ink. In addition, the solid fabrication object includes a mold-processed product manufactured by processing a structure having a substrate such as a recording medium to which the ink is applied. The molded processed product is manufactured from recorded matter or a structure having a form such as a sheet-like form, and film-like form by, processing such as heating drawing or punching. The molded processed product is suitably used for items which are molded after surface-decorating. Examples include gauges or operation panels of vehicles, office machines, electric and electronic devices, and cameras.

Terms such as image forming, recording, printing, and print used in the present disclosure represent the same meaning.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, embodiments of the present disclosure are described in detail with reference to Examples and Comparative Examples but are not limited thereto. In Examples, “parts” and “percent” are “parts by mass” and “percent by mass” unless otherwise specified.

Preparation of Aqueous Liquid Dispersion of Coloring Material that Emits Visible Light at Ultraviolet Radiation

A 2 L flask was equipped with a condenser, a thermometer, a 500 mL separatory funnel for loading monomers, and a stirrer and placed in a warm water tank.

Next, 600 g of water, 10 g of sodium dodecylbenzene sulfonate (NEOPELEX No. 6, manufactured by Kao Corporation), and 5.5 g of higher alcohol-based ether (EMULGEN LS-114, manufactured by Kao Corporation) were loaded in this flask followed by heating the inside to 80 degrees C. during stirring.

Next, 3.5 g of potassium persulfate (manufactured by Tokyo Chemical Industry Co. Ltd.) was loaded into the flask at 80 degrees C. and a monomer mixture of 252 g of styrene (manufactured by Tokyo Chemical Industry Co. Ltd.), 108 g of acrylonitrile (manufactured by Tokyo Chemical Industry Co. Ltd.), and 40 g of acrylic acid (manufactured by Tokyo Chemical Industry Co. Ltd) was added dropwise from the separatory funnel to the flask in three hours during stirring followed by resting for one hour to complete polymerization.

A total of 18 g of a sodium salt of formaline condensate of Pnaphtalene sulfonic acid (DEMOL NL, manufactured by Kao Corporation) and 4 g of a complex of europium: 4,4,4,-trifuloro-1-(2-thienyl-1,3-butanedion (manufactured by Sinloihi Co., Ltd.) were added dropwise at room temperature to the flask during stirring to obtain a homogeneous mixture and then the system was slowly heated to and maintained at 80 degrees C. to complete dyeing in one hour to obtain an aqueous liquid dispersion (Red liquid dispersion A) of milky white particles having a particle diameter of 0.1 μm that emitted red visible light at exposure to ultraviolet radiation.

A total of 18 g of a sodium salt of formaline condensate of special aromatic series sulfonic acid (DEMOL SC-30, manufactured by Kao Corporation) and 4 g of 3-(2-quinolilmethylene)isoindoline-1-one (FP Yellow M, manufactured by Mitsui Chemicals, Inc.) were added dropwise to the mixture at room temperature during stirring in the same manner to obtain a homogeneous mixture and then the system was slowly heated to and maintained at 80 degrees C. to complete dyeing in one hour to obtain an aqueous liquid dispersion (Green liquid dispersion A) of pale yellow particles having a particle diameter of 0.1 μm that emitted green visible light at exposure to ultraviolet radiation.

Next, 18 g of a sodium ester of dialkyl sulfo succinic acid (NEOCOL SW, manufactured by DKS Co., Ltd.) and 4 g of C.I. Fluorescent brightening agent 135 (“Ubitex”, ERN Conq, manufactured by Ciba Geigy A.G.) were added dropwise to the mixture at room temperature during stirring in the same manner to obtain a homogeneous mixture and the system was slowly heated to and maintained at 80 degrees C. to complete dyeing in one hour to obtain an aqueous liquid dispersion (Blue liquid dispersion A) of milky white particles having a particle diameter of 0.1 μm that emitted blue visible light at exposure to ultraviolet radiation.

### Examples 1 to 12 and Comparative Examples 1 to 4

Preparation of Ink

The stealth white inks of Examples 1 to 12 and Comparative Examples 2 to 4 were mixed with organic solvents, surfactants, defoaming agents, pH regulators, fluorescent brighteners, preservatives and fungicides, and deionized water followed by stirring for one hour. The mixture was further stirred to another hour to obtain a homogeneous mixture. Thereafter, each aqueous liquid dispersion was added followed by stirring for one hour. Deionized water was added to make the entire 100 percent by mass to obtain a homogeneous mixture. The thus-obtained mixture was filtered with a polyvinilydene fluoride membrane filter having an average pore diameter of 0.8 μm under pressure to remove coarse particles and dust to obtain the inks of Examples 1 to 12 and Comparative Examples 2 to 4. Green ink was also prepared in the same manner as a stealth non-white ink.

The value of the aqueous liquid dispersion in Table 1 represents the proportion (percent by mass) of the solid content. The solid content contains a coloring material and a resin present as the solid content.

The stealth white ink of Comparative Example 1 was prepared by mixing the red fluorescent ink, the green fluorescent ink, and the blue fluorescent ink prepared in the following manner with a mixing ratio of the red fluorescent ink to the green fluorescent ink to the blue fluorescent of 13.6:1.0:1.6.

Red Fluorescent Ink
Fluorescent pigment (Y₂O₂S:Eu): 58 parts
Microsilica: 3 parts
Alkyd resin: 31 parts
Petroleum solvent: 8 parts

Green Fluorescent Ink
Fluorescent pigment (ZnO:Zn): 50 parts
Microsilica: 4 parts
Organic bentonite: 1 part
Alkyd resin: 37 parts
Petroleum solvent: 8 parts

Blue Fluorescent Ink
Fluorescent pigment (Sr₅(PO₄)₃Cl:Eu): 50 parts
Microsilica: 4 parts
Alkyd resin: 36 parts
Petroleum solvent: 10 parts

Hue Angle and Emission Maximum of Dry Film of Aqueous Liquid Dispersion of Coloring Material That Emits Visible Light at Exposure to Ultraviolet Radiation

Red liquid dispersion A (prepared according to the preparation mentioned above)
Hue angle=25.1 degrees, emission maximum of 620 nm at 365 nm

Red liquid dispersion B (prepared in the same manner as for the Red liquid dispersion A mentioned above except that a complex of europium:4,4,4-trifluoro-1-phenyl-1,3-butane dione (manufactured by Sinloihi Co., Ltd.) was used as the red coloring material.
Hue angle=23.4 degrees, emission maximum of 628 nm at 365 nm

Green liquid dispersion A (prepared according to the preparation mentioned above)
Hue angle=131.0 degrees, emission maximum of 530 nm at 365 nm

Green liquid dispersion B (prepared in the same manner as for the Green liquid dispersion A mentioned above except that Basic Yellow 40 (manufactured by Ciba Speciality Chemicals) was used as the green coloring material.
Hue angle=129.4 degrees, emission maximum of 520 nm at 365 nm

Blue liquid dispersion A (prepared according to the preparation mentioned above)
Hue angle=293.4 degrees, emission maximum of 470 nm at 365 nm

Blue liquid dispersion B (prepared in the same manner as for the Blue liquid dispersion A mentioned above except that C.I. Fluorescent Brightening Agent 52 (manufactured by Ciba Geigy A.G.) was used as the blue coloring material.
Hue angle=292.6 degrees, emission maximum of 460 nm at 365 nm

Organic Solvent

Organic solvent A (glycerin, SP value=17.4 (cal/cm³)⁰⁻⁵, manufactured by Sakamoto Yakuhin Co., Ltd.:)

Organic solvent B (1,2-butanediol, SP value=13.1 (cal/cm³)^{0.5}, manufactured by Tokyo Chemical Industry Co., Ltd.)

Organic solvent C (3-ethyl-3-hydroxymethyloxetane, SP value=11.0 (cal/cm³)^{0.5}, manufactured by Tokyo Chemical Industry Co., Ltd.)

Silicone-Based Surfactant

Silicone-based surfactant A (KF-640, manufactured by Shin-Etsu Chemical Co., Ltd.)

Surfactant B (Surfynol 465, manufactured by Nissin Chemical Industry Co., Ltd.)

Defoaming Agent

KM-72F, manufactured by Shin-Etsu Silicone Co., Ltd.

Fluorescent Brightener

Polyether polyol (Optiact 1-10, manufactured by SAN NOPCO LIMITED)

pH Regulator

2-Amino-2-ethyl-1,3-propane diol (AEPD, manufactured by Tokyo Chemical Industry Co., Ltd.)

Preservatives and Fungicides

LV(S), manufactured by Avecia Inkjet Limited

Print Method

A print sample was made by printing a print chart on a print medium (My Paper, manufactured by Ricoh Co., Ltd.) by an image forming apparatus (IPSiO Gxe5500, manufactured by Ricoh Co., Ltd.) with the ink shown in Table 1 with a printing resolution of 600×600 dpi and an amount attached at 0.8 mg/cm² followed by drying one day and one night. The print chart used was a solid image of 3 cm square formed with dot patterns.

Method of Measuring Color Tone

The print sample placed in a dark room was exposed to ultraviolet radiation emitted from fluorescent lamp type blue black light having a wavelength of 370 nm. The results obtained by measuring the color tone (a* and b*) with a light-shield tubular colorimeter (52002, manufactured by Yokogawa Instruments) were represented according to CIE 1976 L*a*b* colorimetric system. CIE 1976 L*a*b* colorimetric system was regulated at Commission Internationale de l'Eclairage (CIE) in 1976. L* represents luminosity and a* and b* represent color hue and chroma. a*, −a*, b*, and −b* represent respectively red direction, green direction, yellow direction, and blue direction.

The distance between the fluorescent lamp type blue black light and the print sample was adjusted such that the illumination of ultraviolet by an ultraviolet illuminator (UV-M02, manufactured by Orc Manufacturing Co., Ltd.) was 2.0 mW/cm².

Samples for measuring the color tone were prepared by applying 5 mm of each of the red liquid dispersion, the green liquid dispersion, and the blue liquid dispersion onto a glass substrate with a bar coater at 0.8 mg/cm² and drying the liquid dispersions at 60 degrees C. for three hours to measure the color tone (*a, b*).

The hue angle was calculated by the obtained a* and b* values.

Method of Measuring Fluorescent Wavelength

Liquid dispersions containing respective color materials of red, green, and blue and the obtained inks were exposed to ultraviolet radiation having a wavelength of 365 nm to measure the three emission maximums with a spectrophotometer with a spectrophotometer (FP-6500, manufactured by JASCO Corporation).

The ink demonstrates fluorescence emission maxima derived from each coloring material of red, green, and blue contained in the ink.

Method of Measuring Zeta Potential

The liquid sample diluted with deionized water to achieve a total concentration of the resin particles dyed with each coloring material in the stealth white ink of 0.01 percent by mass was placed in a zeta potential measuring device (ELSZ-2000, manufactured by OTSUKA ELECTRONICS CO., LTD.) to measure the zeta potential after the pH of the sample was adjusted to 9 with 0.1 mol/l hydrochloric acid and 0.5 mol/l sodium hydroxide.

Method of Evaluating Storage Stability

The stealth white ink was placed in a sealed bottle (lboy, manufactured by AS ONE Corporation) and stored in a thermostatic chamber (PR-3J, manufactured by ESPEC Corp.) at 70 degrees C. for 14 days. The viscosity of the stealth white ink was measured before and after the storage with a viscometer (RE-85L, manufactured by TOKI SANGYO CO., LTD.). The ink having a viscosity change rate within −5 to +5 percent was suitable for practical purpose.

Measuring Method 1 of Discharging Stability

A solid images of a 10 cm square were printed with the stealth white ink with a run length of 100 by an image forming apparatus (IPSiO Gxe 5500, manufactured by Ricoh Co., Ltd.) at a printing resolution of 600 dpi×600 dpi and an amount of the liquid composition attached at 0.8 mg/cm² to evaluate the discharging stability by visually checking the number of non-discharging nozzles according to the following evaluation criteria. The stealth white ink was evaluated as suitable for practical purpose when the number of non-discharging nozzles was 5 or less.

Evaluation Criteria

S: The number of non-discharging nozzles was zero
A: The number of non-discharging nozzles was two or less
B: The number of non-discharging nozzles was three to five
C: The number of non-discharging nozzles was six or more

Measuring Method 2 of Discharging Stability

The stealth white ink was placed in an image forming apparatus (remodeled based on IPSiO Gxe 5500, manufactured by Ricoh Co., Ltd,) having an ink discharging head including an ink circulation mechanism and evaluated. The ink accommodating unit was filled with the ink and allowed to rest at 35 degrees C. and 30 percent RH for 24 hours. The ink was circulated for two minutes per hour.

The circulation mechanism was operated for one minute just before printing. A nozzle check pattern was printed on a print medium (My Paper, manufactured by Ricoh Co., Ltd.) in an environment of 35 degrees C. and 30 percent RH and the number of the non-discharging nozzles of all of the 385 nozzles was counted and evaluated according to the following evaluation criteria. Grade B or above is desirable for practical purpose.

### Evaluation Criteria

S: The number of non-discharging nozzles was zero
A: The number of non-discharging nozzles was two or less
B: The number of non-discharging nozzles was three to five
C: The number of non-discharging nozzles was six or more

TABLE 1

| | | Stealth non-white ink | | | Stealth white ink | | |
|---|---|---|---|---|---|---|---|
| | | | Gr | | White | White | White |
| | | R color | color | B color | Comparative | Comparative | Comparative |
| | | alone | alone | alone | Example 1 | Example 2 | Example 3 |
| Aqueous | Red | 18.00 | | | | 6.00 | 8.67 |
| liquid | liquid | | | | | | |
| dispersion | dispersion | | | | | | |
| (solid | A | | | | | | |
| portion) | Red | | | | | | |
| | liquid | | | | | | |
| | dispersion | | | | | | |
| | B | | | | | | |
| | Green | | 18.00 | | | 6.00 | 2.67 |
| | liquid | | | | | | |
| | dispersion | | | | | | |
| | A | | | | | | |
| | Green | | | | | | |
| | liquid | | | | | | |
| | dispersion | | | | | | |
| | B | | | | | | |
| | Blue | | | 18.00 | | 6.00 | 6.67 |
| | liquid | | | | | | |
| | dispersion | | | | | | |
| | A | | | | | | |
| | Blue | | | | | | |
| | liquid | | | | | | |
| | dispersion | | | | | | |
| | B | | | | | | |
| Organic | Organic | 20.00 | 19.00 | 18.00 | | 20.00 | 20.00 |
| solvent | solvent A | | | | | | |
| | Organic | | | | | | |
| | solvent B | | | | | | |
| | Organic | | | | | | |
| | solvent C | | | | | | |
| Surfactant | Surfactant | 0.50 | 0.50 | 0.50 | | 0.50 | 0.50 |
| | A | | | | | | |
| | Surfactant | | | | | | |
| | B | | | | | | |
| Defoaming | KM-72F | 0.15 | 0.15 | 0.15 | | 0.15 | 0.15 |
| agent | | | | | | | |
| Fluorescent | Optiact I- | | | | | | |
| brightener | 10 | | | | | | |
| pH regulator | AEPD | 1.00 | 1.00 | 1.00 | | 1.00 | 1.00 |
| Preservatives | LV(S) | 0.05 | 0.05 | 0.05 | | 0.05 | 0.05 |
| and | | | | | | | |
| fungicides | | | | | | | |
| Water | Deionized | Balance | Balance | Balance | | Balance | Balance |
| | water | | | | | | |
| | Total | 100.00 | 100.00 | 100.00 | | 100.00 | 100.00 |
| Color tone | a* | 29.7 | −39.0 | 24.8 | 6.0 | −19.2 | 2.9 |
| | b* | 13.9 | 45.5 | −57.3 | 2.9 | 7.9 | −0.6 |
| | L* | 10.2 | 35.3 | 6.7 | 10.5 | 27.1 | 16.7 |
| RGB ratio | R ratio | — | — | — | 13.6 | 1.0 | 3.3 |
| (G = 1) | G ratio | — | — | — | 1.0 | 1.0 | 1.0 |
| | B ratio | — | — | — | 1.6 | 1.0 | 2.5 |
| Solvent SP value | | 17.4 | 17.4 | 17.4 | — | 17.4 | 17.4 |
| (cal/cm³)^{0.5} | | | | | | | |
| Zeta potential | | −25.2 | −28.5 | −25.3 | — | −26.3 | −25.7 |
| Viscosity change rate | | 0.8 | 0.8 | 0.8 | — | 0.8 | 0.8 |
| (percent) before and after | | | | | | | |
| storage | | | | | | | |
| Discharging stability 1 | | S | S | S | — | S | S |
| Discharging stability 2 | | S | S | S | — | S | S |
| (with circulation) | | | | | | | |
| | | Stealth white ink | | | | | |
| | | White | White | White | White | White | White |
| | | Comparative | Example | Example | Example | Example | Example |
| | | Example 4 | 1 | 2 | 3 | 4 | 5 |
| Aqueous | Red | 7.20 | 7.50 | 6.92 | 7.92 | 8.31 | 9.00 |
| liquid | liquid | | | | | | |
| dispersion | dispersion | | | | | | |
| (solid | A | | | | | | |
| portion) | Red | | | | | | |
| | liquid | | | | | | |
| | dispersion | | | | | | |
| | B | | | | | | |
| | Green | 2.88 | 3.00 | 2.77 | 2.88 | 2.77 | 3.00 |
| | liquid | | | | | | |
| | dispersion | | | | | | |
| | A | | | | | | |
| | Green | | | | | | |
| | liquid | | | | | | |
| | dispersion | | | | | | |
| | B | | | | | | |
| | Blue | 7.92 | 7.50 | 8.31 | 7.20 | 6.92 | 6.00 |
| | liquid | | | | | | |
| | dispersion | | | | | | |
| | A | | | | | | |
| | Blue | | | | | | |
| | liquid | | | | | | |
| | dispersion | | | | | | |
| | B | | | | | | |
| Organic | Organic | 20.00 | 20.00 | 20.00 | 20.00 | 20.00 | 20.00 |
| solvent | solvent A | | | | | | |
| | Organic | | | | | | |
| | solvent B | | | | | | |
| | Organic | | | | | | |
| | solvent C | | | | | | |
| Surfactant | Surfactant | 0.50 | 0.50 | 0.50 | 0.50 | 0.50 | 0.50 |
| | A | | | | | | |
| | Surfactant | | | | | | |
| | B | | | | | | |
| Defoaming | KM-72F | 0.15 | 0.15 | 0.15 | 0.15 | 0.15 | 0.15 |
| agent | | | | | | | |
| Fluorescent | Optiact I- | | | | | | |
| brightener | 10 | | | | | | |
| pH regulator | AEPD | 1.00 | 1.00 | 1.00 | 1.00 | 1.00 | 1.00 |
| Preservatives | LV(S) | 0.05 | 0.05 | 0.05 | 0.05 | 0.05 | 0.05 |
| and | | | | | | | |
| fungicides | | | | | | | |
| Water | Deionized | Balance | Balance | Balance | Balance | Balance | Balance |
| | water | | | | | | |
| | Total | 100.00 | 100.00 | 100.00 | 100.00 | 100.00 | 100.00 |
| Color tone | a | −1.1 | −1.6 | −2.0 | −0.6 | 1.8 | 2.0 |
| | b | −10.4 | −7.8 | −10.0 | −5.4 | −2.1 | 0.0 |
| | L* | 18.2 | 18.2 | 17.5 | 20.3 | 18.8 | 19.0 |
| RGB ratio | R ratio | 2.5 | 2.5 | 2.5 | 2.8 | 3.0 | 3.0 |
| (G = 1) | G ratio | 1.0 | 1.0 | 1.0 | 1.0 | 1.0 | 1.0 |
| | B ratio | 2.8 | 2.5 | 3.0 | 2.5 | 2.5 | 2.0 |

| | | | | | | |
|---|---|---|---|---|---|---|
| Solvent SP value | 17.4 | 17.4 | 17.4 | 17.4 | 17.4 | 17.4 |
| (cal/cm³)^{0.5} | | | | | | |
| Zeta potential | −25.8 | −25.8 | −25.8 | −25.8 | −25.7 | −25.7 |
| Viscosity change rate | 0.8 | 0.8 | 1.0 | 0.8 | 0.8 | 1.2 |
| (percent) before and after | | | | | | |
| storage | | | | | | |
| Discharging stability 1 | S | S | S | S | S | S |
| Discharging stability 2 | S | S | S | S | S | S |
| (with circulation) | | | | | | |

| | | Stealth white ink | | | |
|---|---|---|---|---|---|
| | | White | White | White | White |
| | | Example | Example | Example | Example |
| | | 5 | 6 | 7 | 8 |
| Aqueous | Red | 9.00 | 7.92 | 7.92 | 7.92 |
| liquid | liquid | | | | |
| dispersion | dispersion | | | | |
| (solid | A | | | | |
| portion) | Red | | | | |
| | liquid | | | | |
| | dispersion | | | | |
| | B | | | | |
| | Green | 3.00 | 2.88 | 2.88 | 2.88 |
| | liquid | | | | |
| | dispersion | | | | |
| | A | | | | |
| | Green | | | | |
| | liquid | | | | |
| | dispersion | | | | |
| | B | | | | |
| | Blue | 6.00 | 7.20 | 7.20 | 7.20 |
| | liquid | | | | |
| | dispersion | | | | |
| | A | | | | |
| | Blue | | | | |
| | liquid | | | | |
| | dispersion | | | | |
| | B | | | | |
| Organic | Organic | 20.00 | 10.00 | | |
| solvent | solvent A | | | | |
| | Organic | | 10.00 | 20.00 | 17.00 |
| | solvent B | | | | |
| | Organic | | | | 3.00 |
| | solvent C | | | | |
| Surfactant | Surfactant | 0.50 | 0.50 | 0.50 | 0.50 |
| | A | | | | |
| | Surfactant | | | | |
| | B | | | | |
| Defoaming | KM-72F | 0.15 | 0.15 | 0.15 | 0.15 |
| agent | | | | | |
| Fluorescent | Optiact I- | | | | |
| brightener | 10 | | | | |
| pH regulator | AEPD | 1.00 | 1.00 | 1.00 | 1.00 |
| Preservatives | LV(S) | 0.05 | 0.05 | 0.05 | 0.05 |
| and | | | | | |
| fungicides | | | | | |
| Water | Deionized | Balance | Balance | Balance | Balance |
| | water | | | | |
| | Total | 100.00 | 100.00 | 100.00 | 100.00 |
| Color | a* | 2.0 | −0.5 | −0.3 | 0.3 |
| tone | b* | 0.0 | −5.5 | −5.9 | −6.0 |
| | L* | 19.0 | 19.0 | 18.8 | 19.0 |
| RGB | R ratio | 3.0 | 2.8 | 2.8 | 2.8 |
| ratio | G ratio | 1.0 | 1.0 | 1.0 | 1.0 |
| (G = 1) | B ratio | 2.0 | 2.5 | 2.5 | 2.5 |
| Solvent SP value | | 17.4 | 15.3 | 13.1 | 12.8 |
| (cal/cm³)^{0.5} | | | | | |
| Zeta potential | | −25.7 | −22.8 | −20.5 | −18.3 |
| Viscosity change rate | | 1.2 | −2.0 | −4.8 | −5.2 |
| (percent) before and after | | | | | |
| storage | | | | | |
| Discharging stability 1 | | S | A | B | B |
| Discharging stability 2 | | S | S | S | S |
| (with circulation) | | | | | |
| | | Stealth white ink | | | |
| | | White | White | White | White |
| | | Example | Example | Example | Example |
| | | 9 | 10 | 11 | 12 |
| Aqueous | Red | 7.92 | | 7.92 | |
| liquid | liquid | | | | |
| dispersion | dispersion | | | | |
| (solid | A | | | | |
| portion) | Red | | 7.92 | | 7.92 |
| | liquid | | | | |
| | dispersion | | | | |
| | B | | | | |
| | Green | 2.88 | | 2.88 | |
| | liquid | | | | |
| | dispersion | | | | |
| | A | | | | |
| | Green | | 2.88 | | 2.88 |
| | liquid | | | | |
| | dispersion | | | | |
| | B | | | | |
| | Blue | 7.20 | | 7.20 | |
| | liquid | | | | |
| | dispersion | | | | |
| | A | | | | |
| | Blue | | 7.20 | | 7.20 |
| | liquid | | | | |
| | dispersion | | | | |
| | B | | | | |
| Organic | Organic | 20.00 | 20.00 | 20.00 | 20.00 |
| solvent | solvent A | | | | |
| | Organic | | | | |
| | solvent B | | | | |
| | Organic | | | | |
| | solvent C | | | | |
| Surfactant | Surfactant | 0.50 | 0.50 | | 0.50 |
| | A | | | | |
| | Surfactant | | | 1.00 | |
| | B | | | | |
| Defoaming | KM-72F | 0.15 | 0.15 | 0.15 | |
| agent | | | | | |
| Fluorescent | Optiact I- | 0.10 | | | |
| brightener | 10 | | | | |
| pH regulator | AEPD | 1.00 | 1.00 | 1.00 | 1.00 |
| Preservatives | LV(S) | 0.05 | 0.05 | 0.05 | 0.05 |
| and | | | | | |
| fungicides | | | | | |
| Water | Deionized | Balance | Balance | Balance | Balance |
| | water | | | | |
| | Total | 100.00 | 100.00 | 100.00 | 100.00 |
| Color tone | a* | −0.1 | 0.9 | −1.0 | 0.3 |
| | b* | −5.1 | −6.3 | −4.4 | −7.5 |
| | L* | 23.4 | 17.1 | 20.8 | 16.7 |
| RGB ratio | R ratio | 2.8 | 2.8 | 2.8 | 2.8 |
| (G = 1) | G ratio | 1.0 | 1.0 | 1.0 | 1.0 |
| | B ratio | 2.5 | 2.5 | 2.5 | 2.5 |

| | | | | |
|---|---|---|---|---|
| Solvent SP value | 17.4 | 17.4 | 17.4 | 17.4 |
| (cal/cm³)^{0.5} | | | | |
| Zeta potential | −25.8 | −25.8 | −25.6 | −26.0 |
| Viscosity change rate | 0.8 | 0.8 | 1.5 | 0.3 |
| (percent) before and after | | | | |
| storage | | | | |
| Discharging stability 1 | S | S | S | S |
| Discharging stability 2 | S | S | S | S |
| (with circulation) | | | | |

### Example 13

A printing chart was printed on a print medium (My paper, manufactured by Ricoh Co., Ltd.) with the stealth white ink of Example 2 by an image forming apparatus (IPSiO Gxe 5500, manufactured by Ricoh Co., Ltd.) with a printing resolution of 600 dpi×600 dpi and an amount attached at 0.8 mg/cm². The print chart used was a solid image of 3 cm square formed with dot patterns.

Then, the stealth non-white ink of the green alone was applied to the region where the stealth white ink was applied without drying the stealth white ink. The resulting ink image was dried at room temperature for one day and one night to prepare a print sample.

Also, the stealth non-white ink of the green alone was applied to the region where the stealth white ink was applied after the stealth white ink was dried. The resulting ink image was dried at room temperature for one day and one night to obtain another print sample.

The stealth white ink was dried at 90 degrees C. for one minute.

L*, a*, and b* values of the print samples were obtained according to the method mentioned above.

The results are shown in Table 2.

TABLE 2

| | First stealth ink | |
|---|---|---|
| | (white ink) | Example 13 |
| | Second stealth ink | Example 2 |
| | (non-white ink) | Gr color alone |
| First ink | a* | −17.8 |
| (white ink) | b* | 19.6 |
| without drying | L* | 25.5 |
| process | | |
| First ink | a* | −38.1 |
| (white ink) | b* | 43.8 |
| with drying | L* | 31.2 |
| process | | |

The result of Example 13 indicates that the white image created with the ink for use in Example 2 and dried before applying the second stealth ink (non-white ink) demonstrates the color tone on the same level with that of the second stealth ink.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A stealth white ink comprising:
a red coloring material that emits visible light at exposure to ultraviolet radiation;
a green coloring material that emits visible light at exposure to ultraviolet radiation; and
a blue coloring material that emits visible light at exposure to ultraviolet radiation, wherein a dry film of the stealth white ink has an a* value of from −2.0 to 2.0 and a b* value of from −10.0 to 0 at exposure to ultraviolet radiation having a wavelength of 370 nm according to CIE 1976 L*a*b* colorimetric system.

2. The stealth white ink according to claim 1, wherein the green coloring material has a least mass ratio of the red coloring material, the green coloring material, and the blue coloring material in the stealth white ink.

3. The stealth white ink according to claim 1, containing 2.0 to 3.0 parts by mass of the blue coloring material and 2.5 to 3.0 parts by mass of the red coloring material relative to 1.0 part by mass of the green coloring material.

4. The stealth white ink according to claim 1, wherein the stealth white ink demonstrates three fluorescence emission maxima of from 605 to 645 nm, from 505 to 545 nm, and from 445 to 485 nm at exposure to ultraviolet radiation having a wavelength of 365 nm.

5. The stealth white ink according to claim 1, further comprising an organic solvent having a mixing SP value of 13.0 (cal/cm³)^{0.5} or greater.

6. The stealth white ink according to claim 1, further comprising a polyether polyol.

7. An ink set comprising:
the stealth white ink of claim 1; and
a stealth non-white ink.

8. A printing method comprising:
applying the stealth white ink of claim 1 to a substrate; and
drying the stealth white ink that has been applied to the substrate.

9. A printing method comprising:
applying the stealth white ink of claim 1 to a substrate; and
applying a stealth non-white ink to the substrate.

10. The printing method according to claim 9, wherein, in the applying the stealth white ink, the stealth white ink is applied to one of an entire surface of the substrate and a region of the substrate where the stealth non-white ink is applied.

11. A printing device comprising:
a container containing the stealth white ink of claim 1;
a liquid discharging head configured to discharge the stealth white ink; and
a circulation assembly including a pressure generating device that is configured to circulate the stealth white ink.

12. A printing device comprising:
a container containing an ink set comprising the ink set of claim 7; and
a liquid discharging head configured to discharge the stealth white ink; and
a circulation assembly including a pressure generating device that is configured to circulate the stealth white ink.
